(19) United States
(12) Patent Application Publication
(10) Pub. No.: US 2011/0307300 A1
(43) Pub. Date: Dec. 15, 2011

(54) METHOD AND SYSTEM FOR IDENTIFYING AND THEN PROBABALISTICALLY PROJECTING AND AGGREGATING DIFFICULT-TO-PREDICT INDUSTRY OPERATING STATISTICS

(75) Inventor: Henry Charles Stockman, San Francisco, CA (US)

(73) Assignee: NPA VISION, INC., San Francisco, CA (US)

(21) Appl. No.: 13/104,416

(22) Filed: May 10, 2011

Related U.S. Application Data
(60) Provisional application No. 61/395,242, filed on May 11, 2010.

(51) Int. Cl. G06Q 10/00

(52) U.S. Cl. 705/7.37

(57) ABSTRACT

A method and system of projecting at least one key operating statistic for a selectable business entity within that industry. Data about a business entity includes at least one key operating statistic and is presented to a plurality of users. Each of the users makes at least one projection of the key operating statistic. All of the projections thus created are aggregated into a single probabilistic expression that expresses not only a range of projected magnitudes of the key operating statistic but also the respective chances of the projected magnitudes' occurrences. The expression is preferably a cumulative probability density function (CDF). In this way, a variety of financial statistics is aggregated and presented to enable users to: isolate the statistic most germane to a company's prospects, project the statistic based on historical data, derive an ultimate projection of the statistic as a CDF that integrates the projections of multiple users.

### RELATED APPLICATIONS

Domestic priority is claimed from U.S. Provisional Patent Application No. 61/395,242 filed May 11, 2010, entitled “NPA Solutions”, the entirety of which is incorporated by reference herein.

### BACKGROUND OF THE INVENTION

1. Field of the Invention

The invention relates generally to financial analysis, and more particularly to a system and method for making projections concerning the relative health of a business entity in light of one or more key operating statistics that are industry-specific and typically difficult to predict.

2. Description of Related Art

Most industries have a key operating statistic crucial to a company's prospects. For example, for the banking industry, it is future loan losses; for the semiconductor industry, it is the book to bill ratio; for the airline industry, it is load factor; for the tobacco industry, it is the contingent liability from health lawsuits; for the biotechnology industry, it is likelihood of FDA approval for a drug. This listing is meant to be inclusive and exemplary only; other key operating statistics are relevant to other industries.

An effective method and service for identifying and predicting the crucial statistic does not exist, because existing data services such as Bloomberg, Thompson Reuters, International Data Services, Capital IQ (a division of Standard and Poor's) are motivated to capture the widest possible audience and therefore favor exposing all types of statistics. These existing data services believe that users want to make up their own minds, that users vary in type and therefore have diverse information requirements and that users function under a legacy of their own methodology. Outside of existing data services, there are analytic groups such as credit rating agencies and securities analysts, qualified to identify and focus on the statistic but elect to publish and consider a variety of statistics in an effort to, like the data service companies, appear thorough and allow their customers to make up there own mind.

Despite the fact that in most cases subjectivity and multiple variables makes a projection of the statistic difficult, and that such difficulty would be mitigated by collaboration among those qualified to make individual estimates, there is no forum for such collaboration due to a number of factors. Among the factors are competitive position, adherence to a “unique” method associated with a would-be estimator's brand as well as confidentiality. Something far short of collaboration exists in the form of a consensus on “earnings” or “stock recommendations” put forth by some who aggregate the work of securities analysts, but not the key operating statistic. Furthermore, that consensus has limited statistical relevance in terms of probability theory.

### SUMMARY OF THE INVENTION

Broadly speaking, the invention includes a method of probabilistically projecting at least one industry-specific key operating statistic for a selectable business entity within that industry. The inventive method includes the following steps. Historical data about a business entity within a specific industry is presented to plurality of users, and the data includes at least one key operating statistic. Each of the users is enabled to make at least one projection of the key operating statistic for the business entity. All of the projections created via the enabling step are aggregated into a single probabilistic expression. The probabilistic expression created via the aggregation step expresses not only a range of projected magnitudes of the key operating statistic but also the respective chances of the projected magnitudes occurrences. Preferably, the single probabilistic expression includes a cumulative probability density function.

Preferably, in one embodiment, the presenting step further includes the steps of presenting a plurality of key operating statistics and presenting macroeconomic data to the user relevant to the industry. The enabling step further includes the steps of having the user: i) examine the plurality of key operating statistics; ii) select one of the key operating statistics from the plurality of key operating statistics based on the presented macroeconomic data; and iii) generate at least one projection of the key operating statistic. More preferably, step iii) further includes the steps of: providing a plurality of projections of the selected key operating statistic; and assigning to each projection in the plurality of projections a level of likelihood of occurrence.

The assigning step may preferably include the step of selecting from among a fixed number of preset likelihoods. For example, the fixed number of present likelihoods may be at least three likelihoods, and may more preferably includes a 25% pessimistic outcome, a 50% most likely outcome, and a 25% optimistic outcome. In the alternative, the assigning step may include the step of allowing the user to self-generate likelihoods for the user's projections, giving the user the autonomy to determine the number of projections and the respective probabilities from a continuous or discrete range of values. In one embodiment, the minimum number of users is 5, and the minimum number of projections per user is 3.

The aggregating step preferably further includes the steps of: converting each of the projections of the users into the numerical equivalent of a probability density function; converting the probability functions into a weighted average probability function; and taking the integral of the weighted average probability distribution to create a cumulative probability density function. Preferably, the taking the integral step is approximated, e.g., via at least one of the trapezoidal rule or the rectangle method.

In simplified terms, relating the invention to a bank within the financial industry, the invention:

1) Presents data enabling the user to diagnose a bank.

2) Gives the user tools to make his own projections of future loan losses.

3) Allows the user to include his projection with others to form a crowd of estimates.

4) Displays the crowd of estimates as a probabilistic function with y being probabilities and x being future charge-offs i.e., a cumulative distribution function.

### BRIEF DESCRIPTION OF THE DRAWINGS

FIGS. 1-19 are exemplary screen shots of an interactive website in accordance with the invention.

FIGS. 20A-J are spreadsheets of data inputs for the web based database.

### DETAILED DESCRIPTION OF THE INVENTION AND DRAWINGS

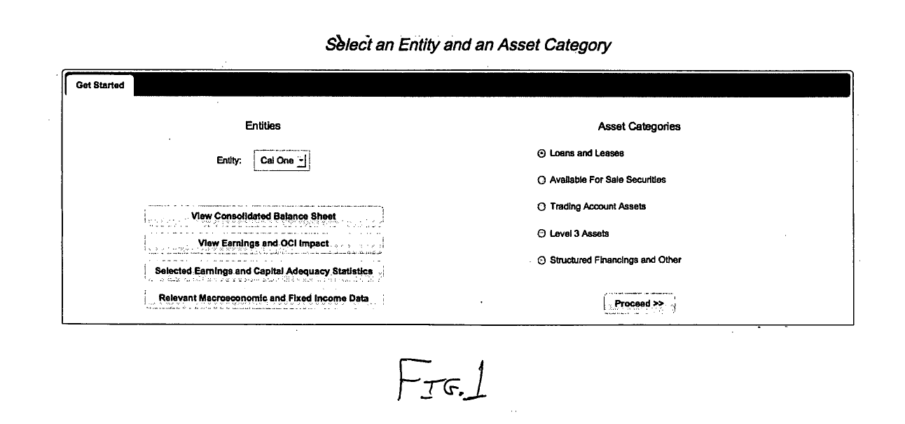

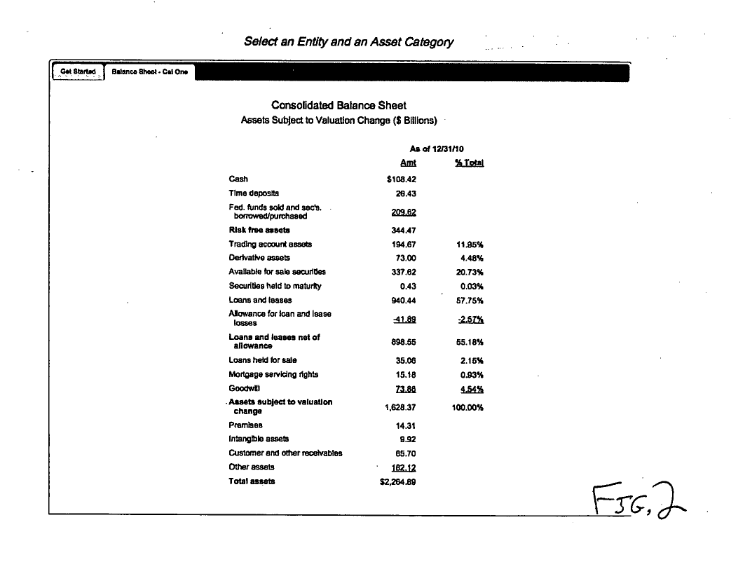

Description will now be given with reference to the attached FIGS. 1-20. It should be understood that these figures are exemplary in nature and in no way serve to limit the scope of the invention, which is defined by the claims appearing hereinbelow.

FIG. 1 depicts a web page user interface entitled “Select an Entity and an Asset Category” This is the gateway or introduction to the site's overall functionality. It does two things: first, it initiates the diagnostic process by isolating among the potential weaknesses of a bank the weaknesses which persist; second, it guides the user to other areas of the site where those weaknesses can be examined in further detail.

The initiation of the diagnostic process begins after the user has selected a bank to examine by selecting a bank by name in the “Entity Box” (Cal One is a fictional choice being made) the process is continued by exploring any of the four menu choices to the left in no particular order, as follows.

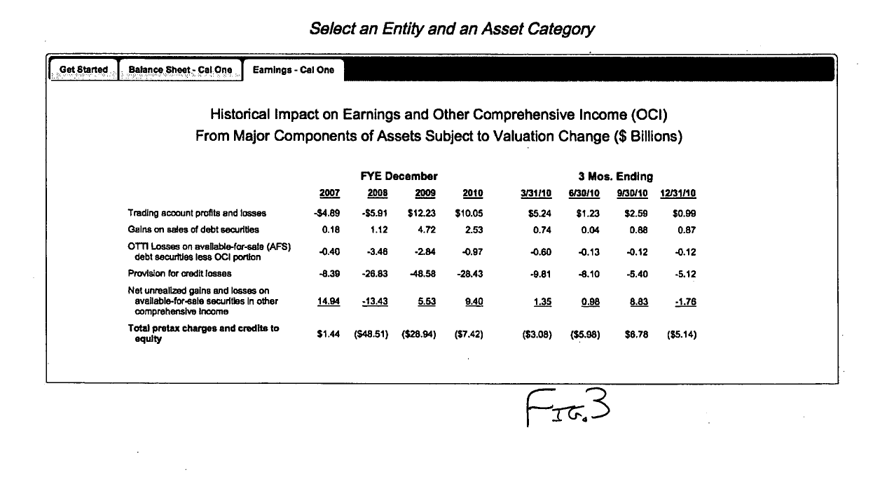

When the user selects “View Consolidated Balance Sheet” in FIG. 1, the user is directed to the current balance sheet as shown in FIG. 2, with assets subject to valuation change distinguished from risk free assets and other assets. This distinction is important because banks have a combination of risk free assets and assets traditionally termed “at risk” (which is termed herein “Assets Subject to Valuation Change,” both terms are synonyms and interchangeable) with the quantity of risk free assets an amount of assured liquidity decided on by the bank under the supervision of regulators. The types of assets traditionally termed “Assets Subject to Valuation Change” make up the rows below the risk free total and consist of categories generating a subtotal. To the right of all components of “Assets Subject to Valuation Change” are percentages showing the percentage contribution of each component of “Assets Subject to Valuation Change” to the total of “Assets Subject to Valuation Change.” These percentages highlight for the benefit the user where concentrations of “Assets Subject to Valuation Change” exist.

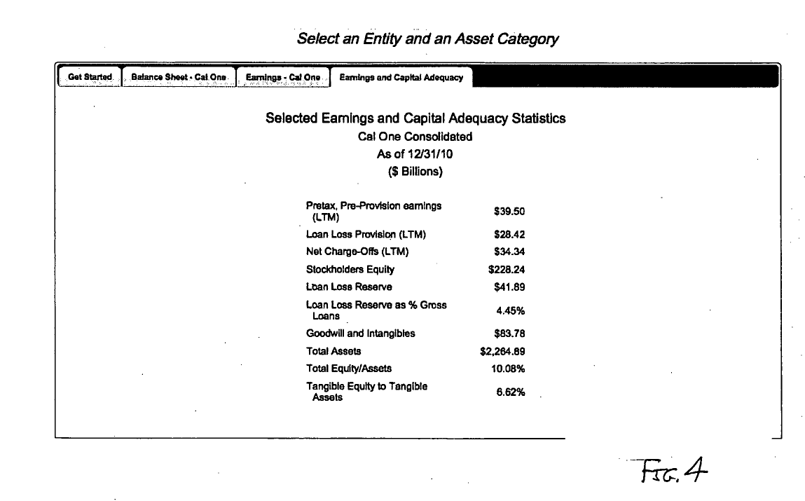

In FIG. 3, View Earnings and OCI Impact, the screen shows the impact on stockholder's equity either through the income statement or directly in the OCI account of changes in the value of “Assets Subject to Valuation change.” A bank's principal earning assets generate interest revenue which is offset by interest expense paid on deposits, the subtraction of this expense from this revenue, net interest income is the primary source of profits for a bank, however, the principal earning assets namely loans, available for sale securities and trading account assets vary in value as assets throughout an accounting period. And these valuation changes are also reflected in the income statement, which is captured in this exhibit. In the case of Cal One during the financial crisis in 2008 these valuation changes were all significantly negative. But since then it is only Loans and Leases primarily as evidenced by the large loan loss provision, which have had a negative impact with available for sale securities being the second.

Selected Earnings and Capital Adequacy Statistics, FIG. 4. Running top down, FIG. 4 shows: first, a comparison between pre provision earnings, net charge-offs and the loan loss provision. In other words the bank's ability from its core earnings to cover loan losses and the adequacy of its current provisioning for loan losses; and second, basic balance sheet capital adequacy measures with the most important being tangible equity to assets. The minimum level or line in the sand drawn by regulators for tangible equity to assets is 5%. The combination of the these statistics shows: that Cal One's core earnings are exceeding loan losses although loan losses are eliminating 90% of those core earnings; that the bank is providing less for loan losses than they are actually charging off; that their loan loss reserve is a healthy percentage of loans, normally the percentage is 2% but that this excess reserve may be necessary given the low tangible equity to asset ratio.

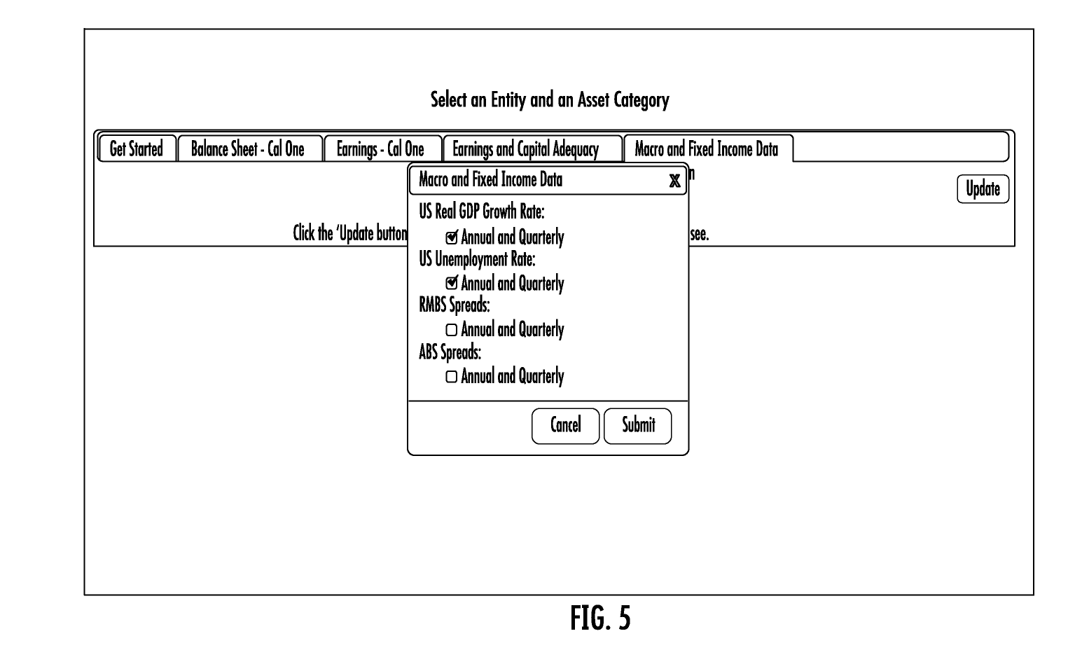

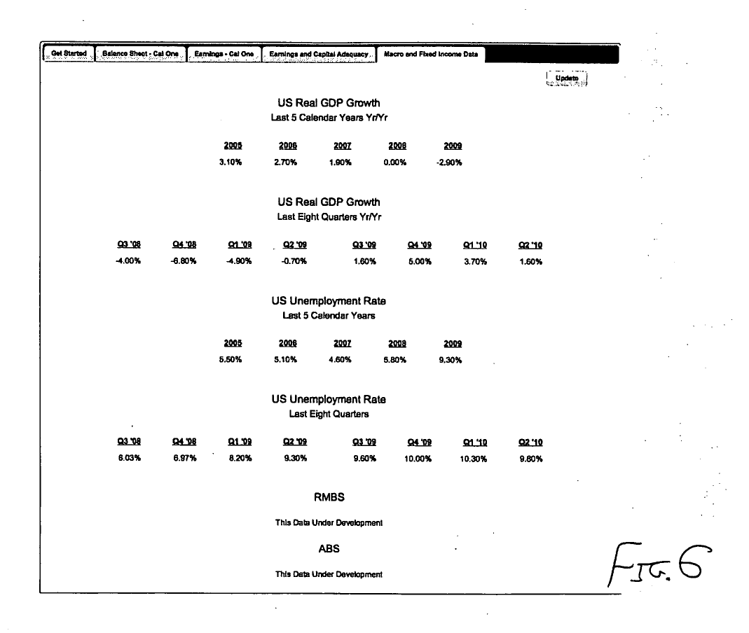

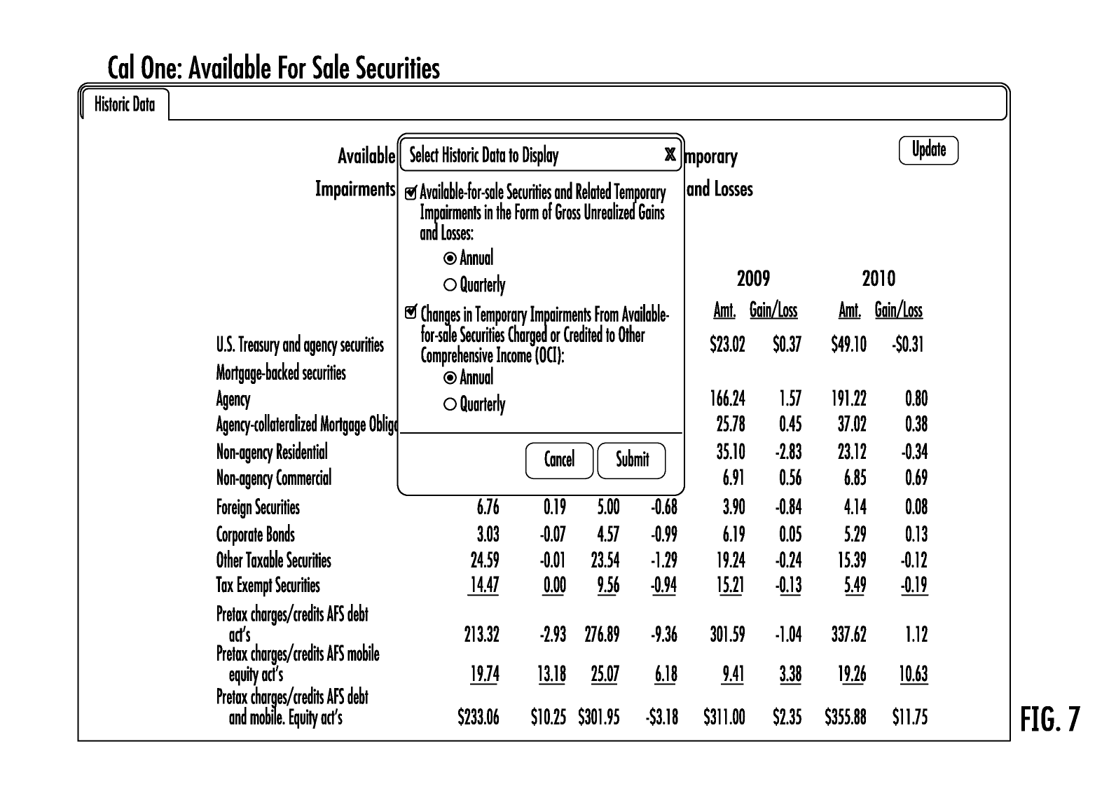

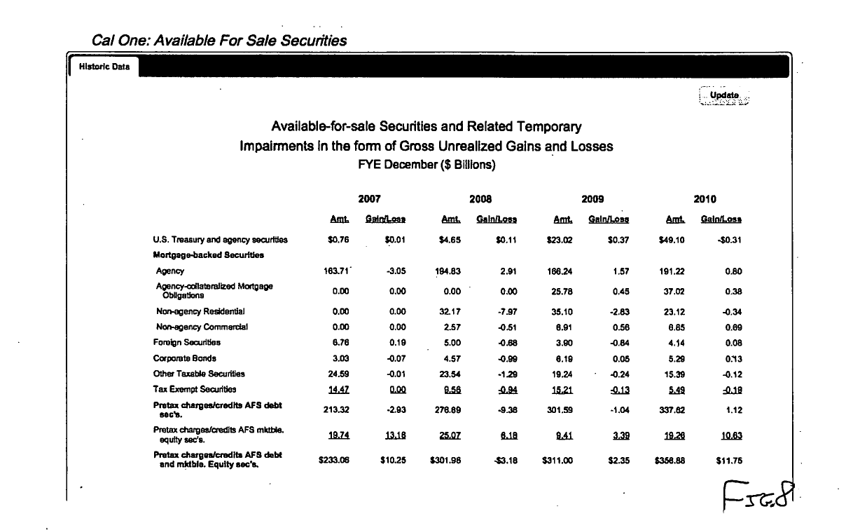

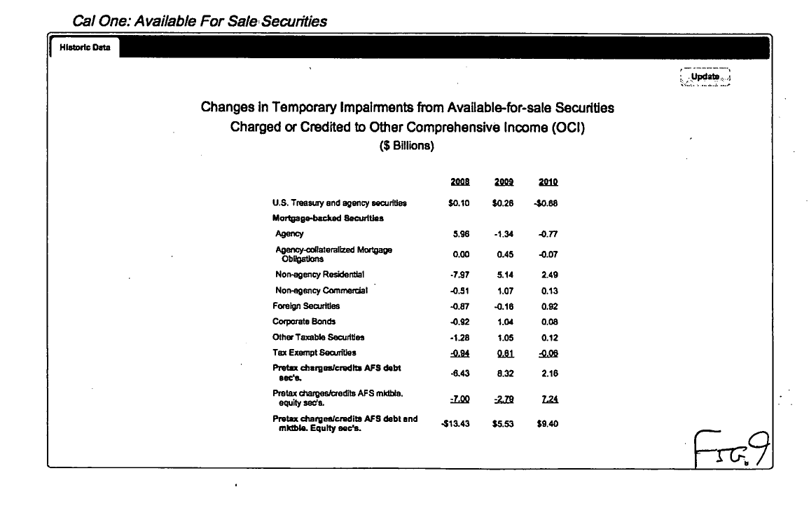

The fourth box to the left on FIG. 1, “Relevant Macroeconomic and Fixed Income Data”, shifts the user to FIG. 5, which shows annual and quarterly data on GDP growth and unemployment. These are data sets typically viewed for historical and recent trends in economic strength, which impact loan losses. FIG. 6 also shows RMBS and ABS spreads which is a data set measuring historical trends in the value of bonds from which the health of a bank's residential mortgages and credit card receivables may be assessed. Additionally the site intends to have data on derivatives whose price trends may dictate the value of many of the assets comprising “Assets subject to valuation change” (FIG. 2). By derivatives we mean things whose prices other things are derived by. A good example of such a derivative, which has a high priority for the inventive system and method, would be some of the Markit indices, which show the value of both securities and loans based on the cost of credit, default swap insurance. The content of this fourth box is distinguished from the three above it in that the data is not specific to the bank selected but still helps a user to direct his attention to areas of concern, therefore guiding the user to other areas of the site where weaknesses can be examined in further detail.

In summary, having looked at the left side of “Select an Entity and An Asset Category” FIG. 1 we have completed the initial phase of the diagnostic process which has revealed: what the major risky assets are and how those risky assets have impacted the bank's equity over time, the adequacy of the bank's inherent earnings power and capital, and what the economic outlook and price trends in certain bonds says about the future value of the risky assets. This initial phase of the diagnostic process also tells us that if we examine Loans and Leases, Available For Sale Securities, and Trading Account Assets we will have examined more than 90% of the risky assets. We next move to the right side of “Select an Entity and an Asset Category” FIG. 1 where the first three menu choices on the right do just that.

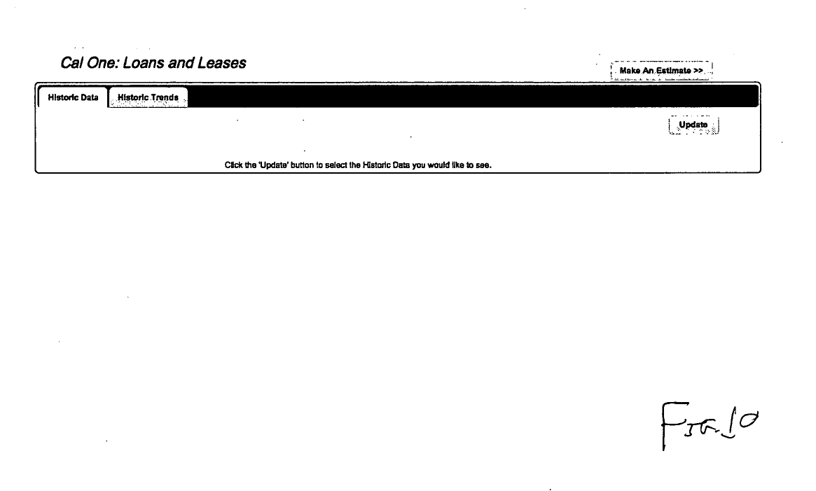

They can be examined in no particular order. Clicking on “Available for Sale Securities” takes you to a menu choice “Select Historic Data to Display” in FIG. 7 which gives you a choice of viewing on either an annual or recent quarterly basis two quantities. First “Available-for-sale Securities and Related Temporary Impairments in the Form of Gross Unrealized Gains and Losses” (the “Annual” version of which is displayed in FIG. 8) for each type of security within the portfolio of the Available for Sale Securities portfolio. Second, “Changes in Temporary Impairments From Available-for-sale Securities Charged of Credited to Other Comprehensive Income (OCI) “(the “Annual” version of which is displayed in FIG. 9) meaning how much the unrealized gains and losses in the “First” quantity defined above in this paragraph have changed over consecutive accounting periods with such changes impacting dollar for dollar the “Other Comprehensive Income” account which is a component of stockholder's equity.

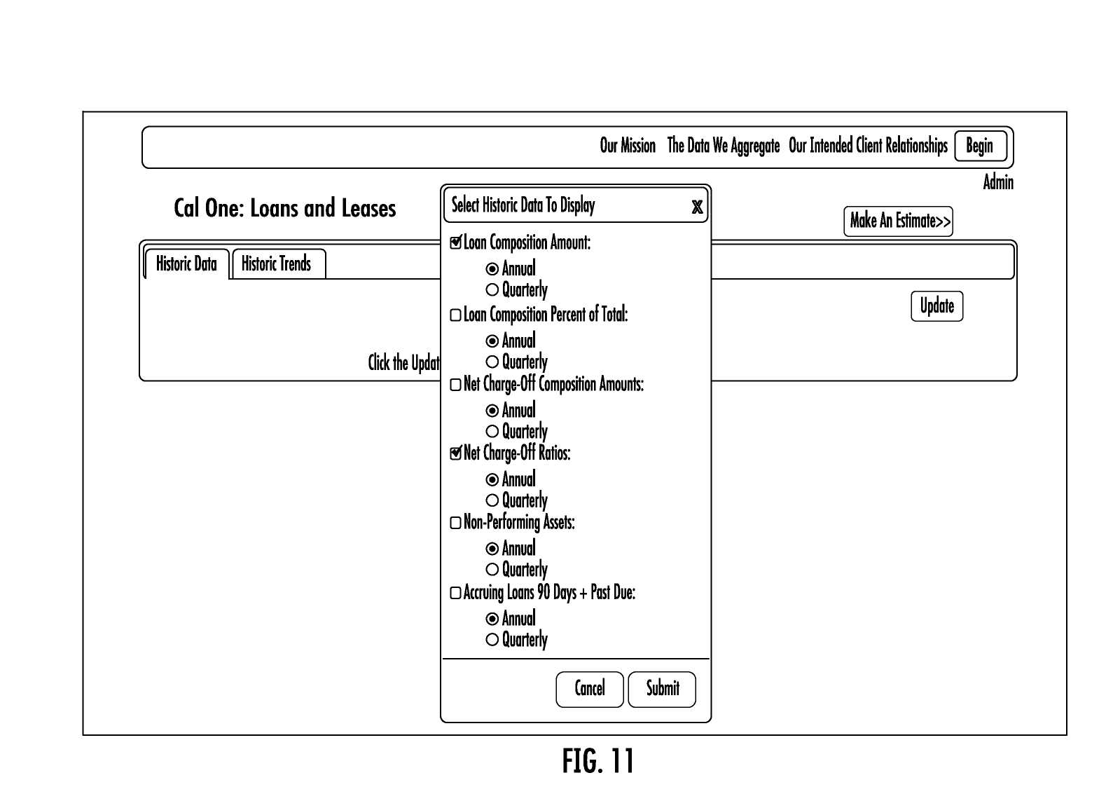

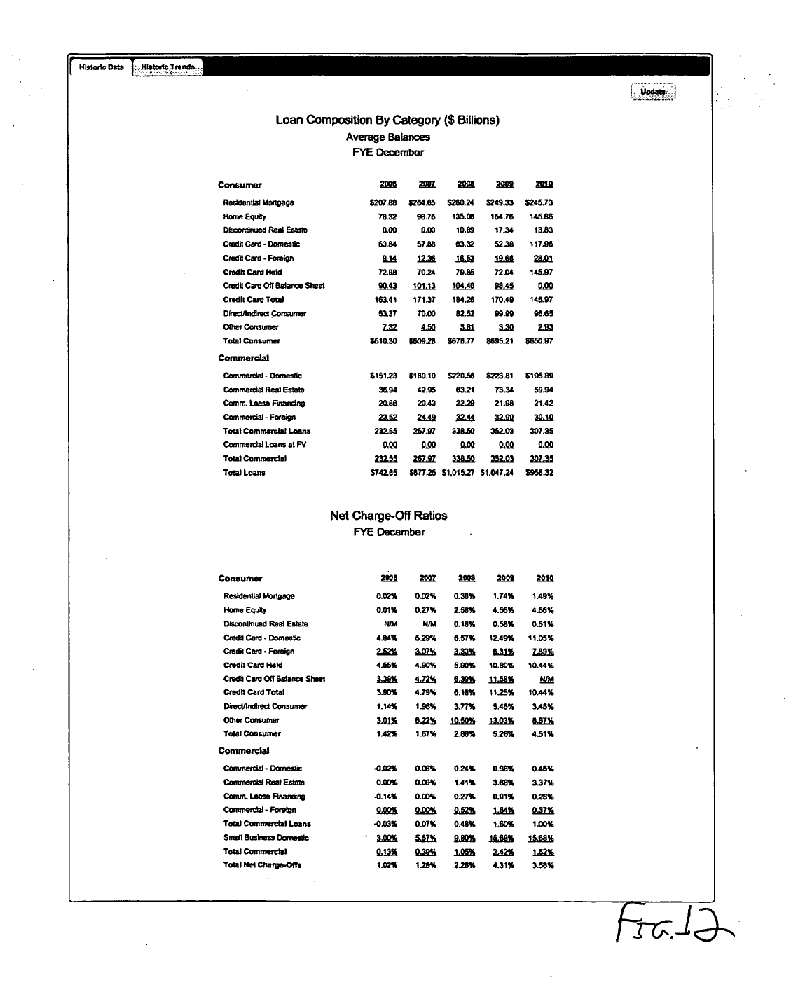

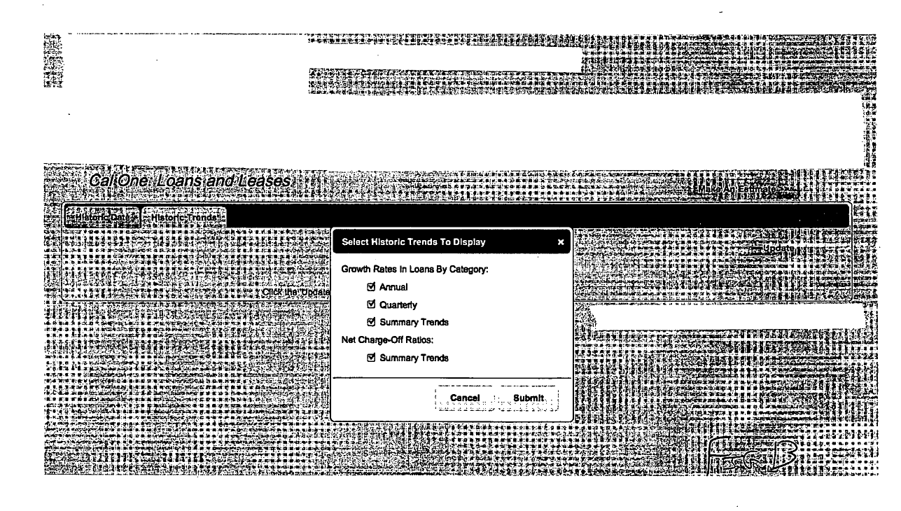

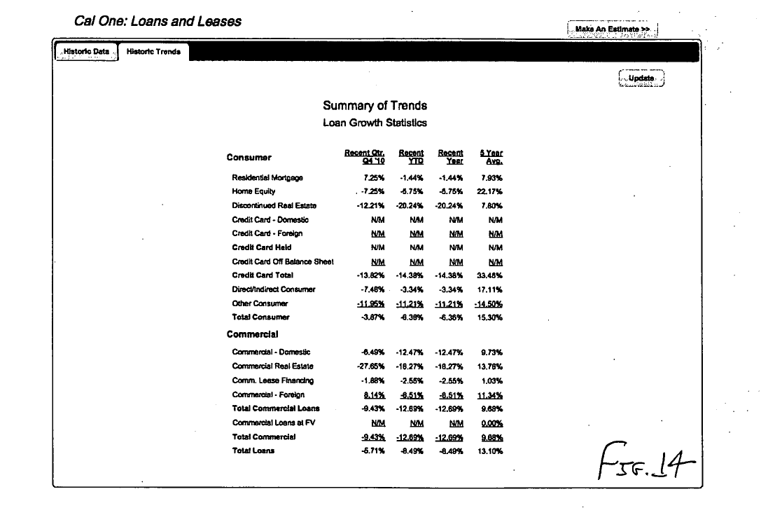

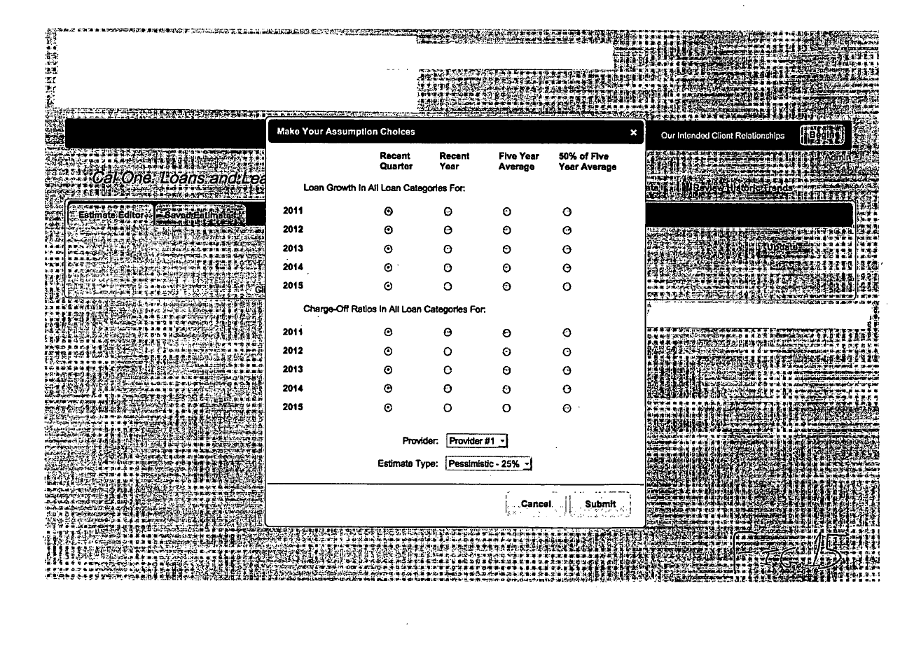

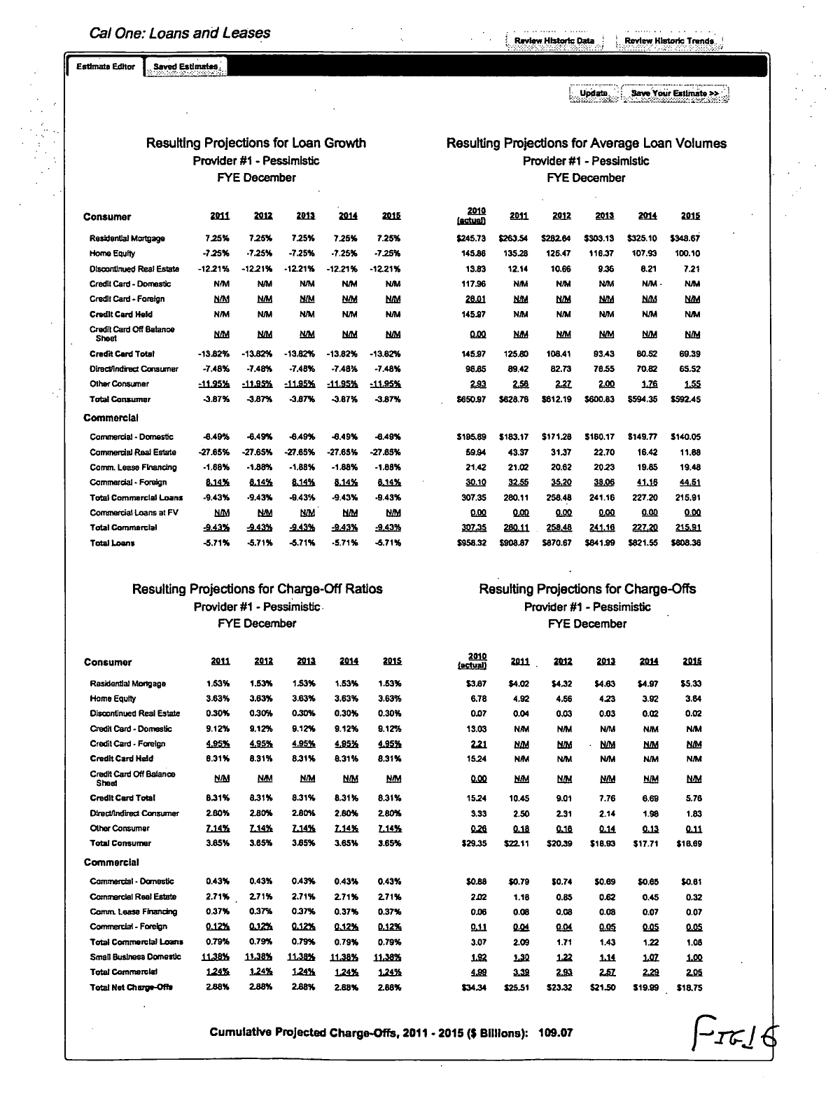

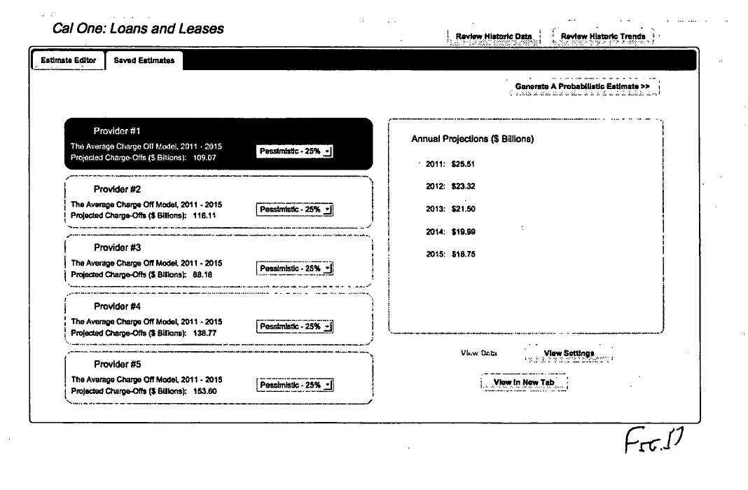

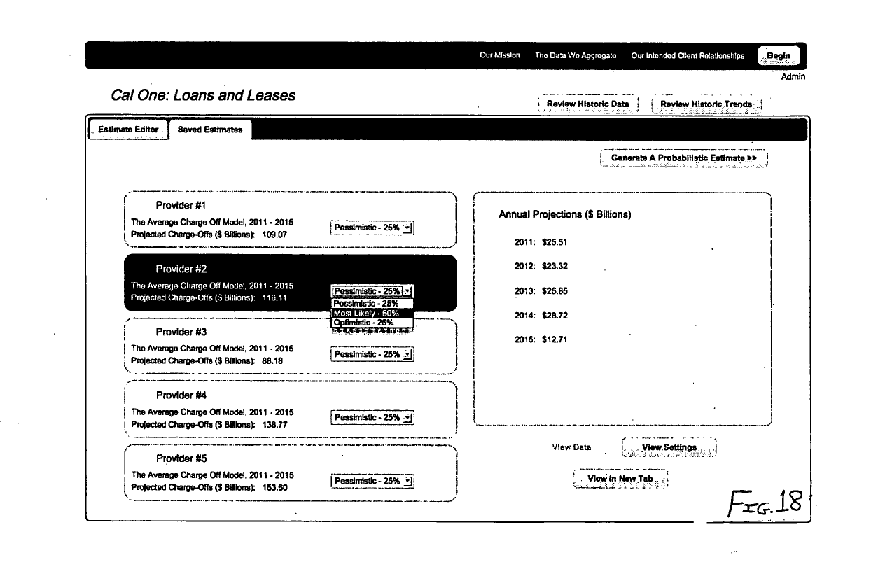

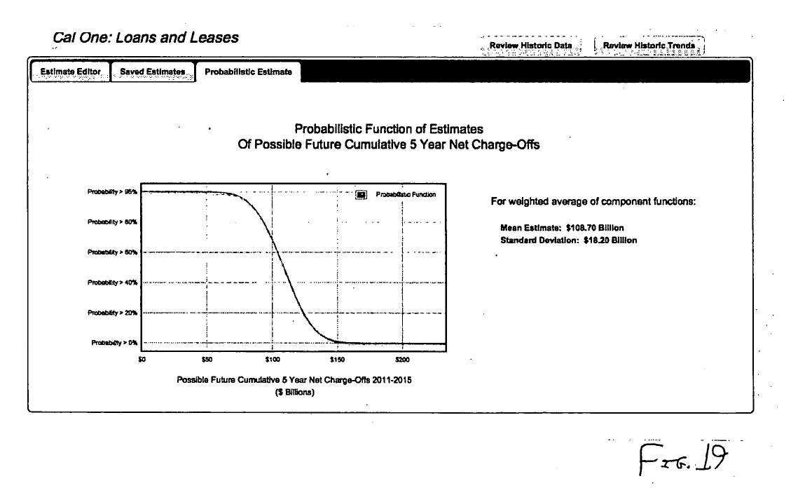

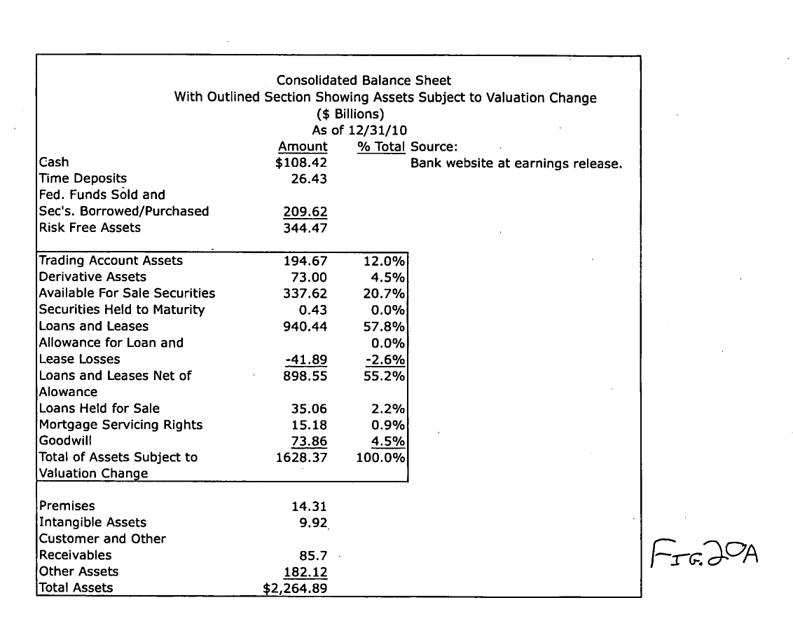

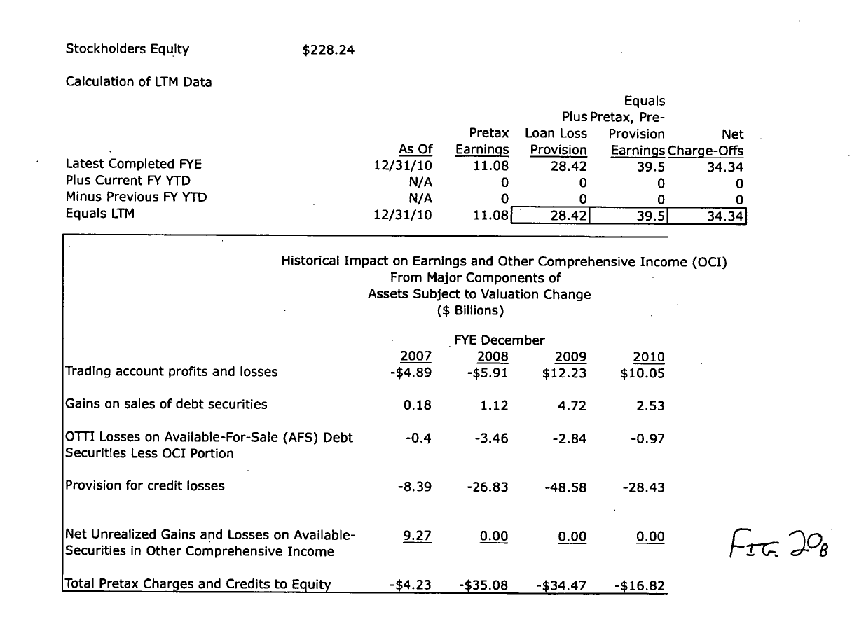

Clicking on the “Trading Account Assets”, “Level 3 Assets”, and “Structured Financings and Other” menu choices of FIG. 1 provides similar detail to that shown in FIGS. 8 and 9 and completes the second phase of the diagnostic process. We have narrowed down where further analytic effort should be devoted to “Loans and Leases” because it is here that by far the largest losses are occurring. Clicking on the Loans and Leases tab of FIG. 1 and hitting the “Proceed” button below takes you to a choice of viewing either historic data or historic trends for Loans and Leases as shown in FIG. 10 and by clicking the update tab while the historic data option of FIG. 10 is active shows a series of menu choices titled “Select Historic Data to Display” FIG. 11 wherein important credit metrics of the loan portfolio on an annual and quarterly basis can be viewed. An example of such a choice is FIG. 12 wherein the user has chosen to view Loan Composition and Net Charge-Off Ratios concurrently on one sheet on an annual basis for all loan categories. Returning to FIG. 9 and clicking on the update tab while the historic trend option of FIG. 9 is active shows a series of menu choices titled “Select Historic Trends To Display” FIG. 13 with menu choices of historic trends in loan growth rates and charge-off ratios for various time periods. This leads to screen shot FIG. 14 which is the result of choosing “Summary Trend Trends in Loan Growth”.

This ends the second phase of the diagnostic process where we have examined in detail 90% of the risky assets, namely Available For Sale Securities, Trading Account Assets, and Loans and Leases as well as Level 3 Assets and Structured Financings and Other. The conclusion is that the only losses that persist among the risky assets since the financial crisis are loan losses hence it is this type of loss that we should model. And that is done by clicking on the “Make and Estimate” button at the upper right of screen shot FIG. 10.

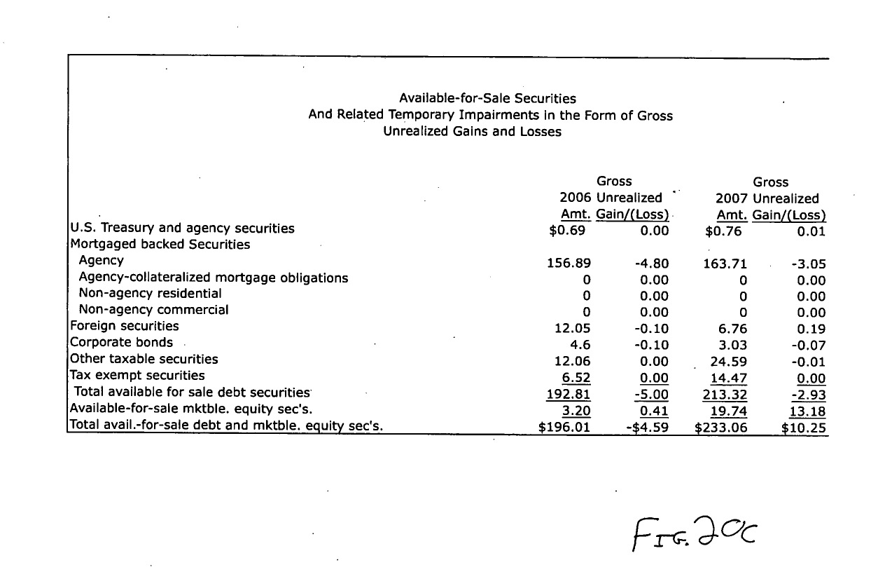

Making an Estimate. It is at this juncture that the site moves into an important role—as an estimating tool. Up to this juncture it has provided users with credit metrics on the loan portfolio. Users are therefore now equipped to make assumption choices regarding loan growth and charge-off ratios going forward for the next five years for the purpose of generating a five-year projection of net charge-offs. A projection of net charge offs is important because without it one does not know if reserves are adequate. The average charge-off method is selected because bank regulators have traditionally advocated it as a guide and it is traditionally reliable. Making those choices are implemented in screen FIG. 15. “Make your Assumption Choices”.

FIG. 15 shows an assumption grid for the average charge-off method. As a structure the average charge-off method is simple: the average of historical charge-off ratios applied to forecasted loans, however the formula version of the structure depends on historic time periods chosen to set the charge-off ratio and the loan growth rate. Some users and providers (see definition of provider below) may want to use the average of the past five years given their opinion that the credit cycle is returning to normal while other providers viewing current credit conditions as more permanent may want to use the past quarter. An additional column may optionally be added to the assumption grid to enable a user and a provider to input their own assumptions for loan growth and charge-off ratios in the event they consider the assumptions choices given to be less suitable.

The definition of a “Provider”: A user of the service who is estimating net charge-offs and contributing them to a community of estimators to create a probabilistic crowd sourced estimate of net charge-offs.

The Provider is enabled to make a plurality of estimates. In one embodiment, the Provider is enabled to make at least three estimates and assign them any probability s/he deems appropriate. In the exemplary embodiment of the figures, the Provider has the ability to make three types of estimates from the assumption grid above and select from specific preset probabilities, i.e., characterize them as:

25% Pessimistic

50% Most Likely

25% Optimistic

Note: The average charge-off method is a predictive model or structure with formulas into which data from the database is put. There are other predictive models designed to predict loan losses that have more sophistication. Additionally the applicability of any predictive model varies according to loan type. To satisfy these two needs of sophistication and applicability, the invention is intended to include alternative models available to providers at their choice. Such models may include regressive analysis, roll rate models, credit metrics versus economic variables, employment data, gross domestic product, and the like.

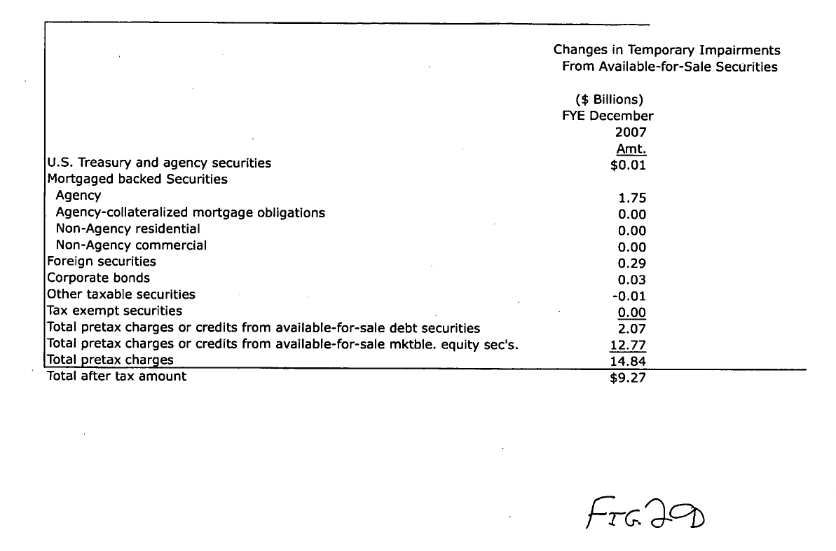

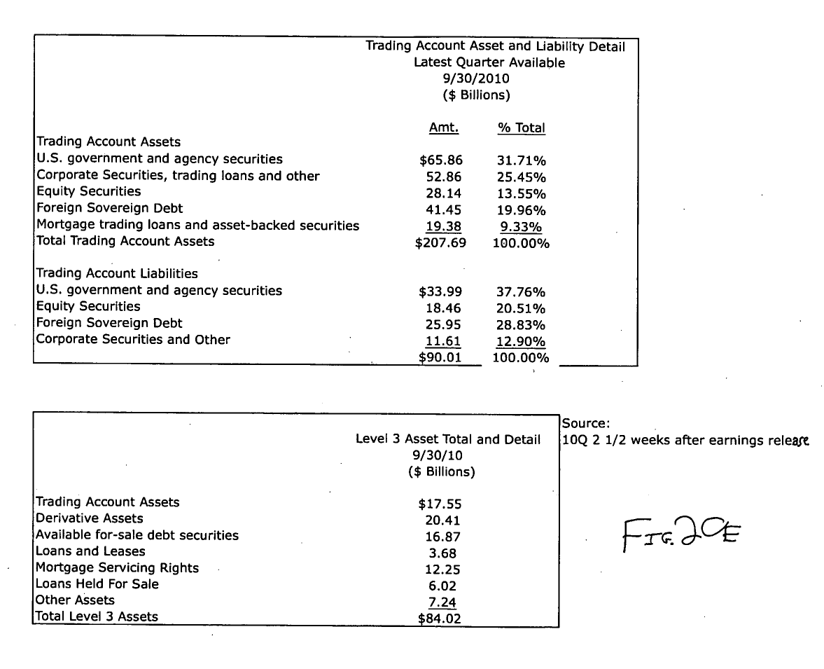

In the exemplary embodiment, five Providers are participating; the invention is scalable and contemplates any number of Providers as may be practical. Each Provider is identified by a number from 1 to 5 and is requested to submit three estimates as described above namely 25% Pessimistic, 50% Most Likely, and 25% Optimistic. Given capacity for five providers this will generate a total of 15 projections of future 5 Year Net Charge Offs if all providers contribute. One of the resulting estimates is shown on screen shot FIG. 16. This is an example of the result of Provider #1 having submitted his Pessimistic Assumption. It shows by loan category all the elements leading to and including the five-year projection of net charge-offs and it is a result of inputs submitted in screen shot FIG. 15 above.

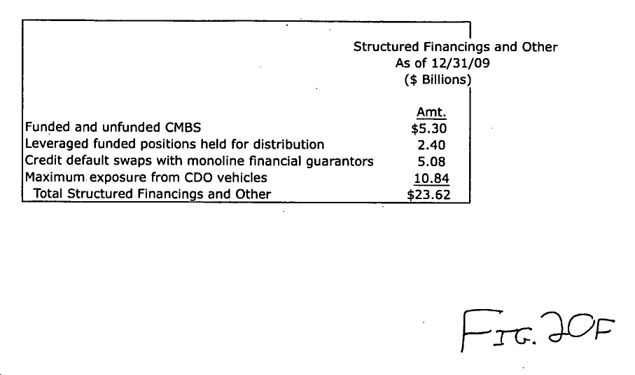

Submitting and saving the resulting estimate (Screen Shot FIG. 17). When the “Submit” button is hit on FIG. 15 an additional submit button is required (not shown) and the pessimistic estimate of charge-offs is now saved as indicated by a resulting highlighting in reverse print.

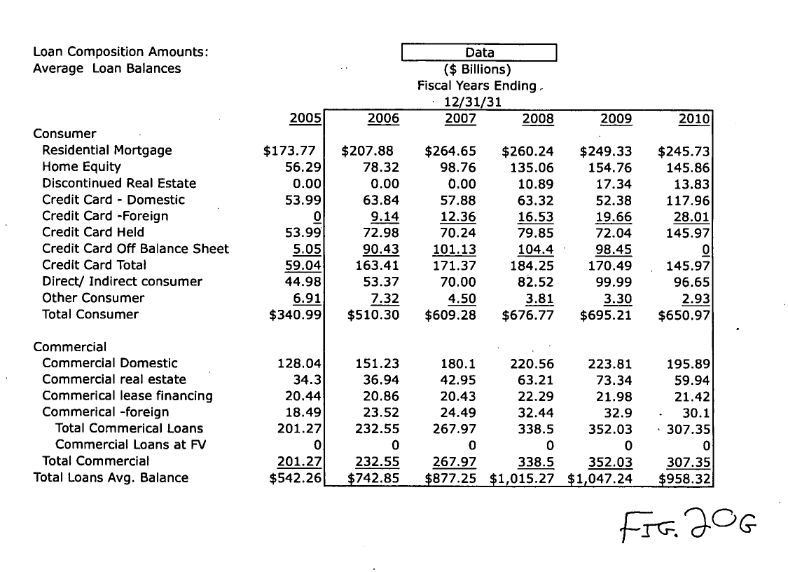

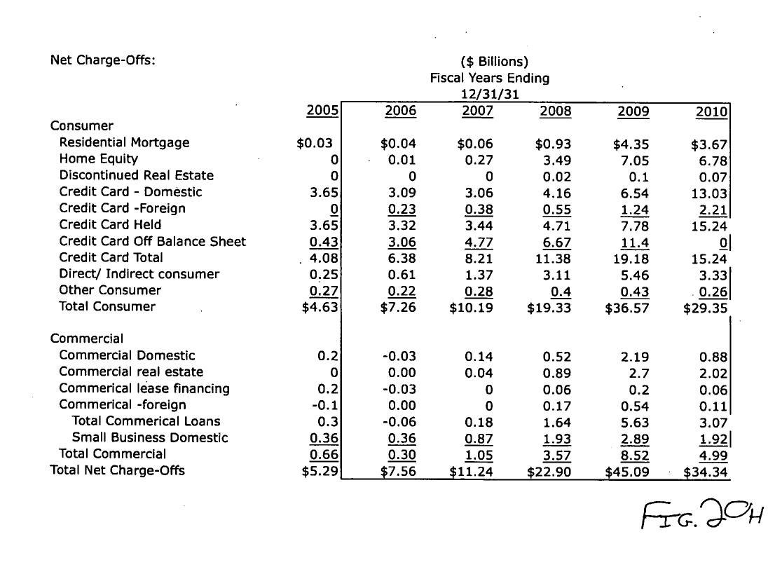

Reviewing the saved estimates of other Providers: FIG. 18. Any provider by clicking his panel wherein it becomes highlighted and then scrolling within the Pessimistic, Most Likely, or Optimistic estimates he has submitted may review key elements of his projection work by clicking on:

“View Data”: to see annual projections of net charge-offs.

“View Settings”: to see underlying assumptions.

“View in New Tab”: to see data equivalent to Screen shot FIG. 16 above i.e. by loan category all the elements leading to and including the five year projection of net charge-offs.

Estimate Editor—to the upper left of Screen Shot FIG. 17 is a tab “Estimate Editor.” Clicking on it enables a return for any provider to the “Make Your Assumption” page wherein the provider can vary any of his assumptions thereby regenerating and resaving new estimates of net charge-offs.

Generating the Probabilistic Estimate: by clicking on the upper right tab “Generate a Probabilistic Estimate” of screen shot FIG. 17 or FIG. 18 the website performs the following in order:

Converts the three estimates of each of the providers into the numerical equivalent of a probability density function.
Converts those probability functions into a weighted average probability function.
Takes the integral of that weighted average probability distribution and creates a Cumulative Probability Density function (CDF). It is this CDF that is displayed (screen shot 19) and shows a range of probabilities on the vertical axis of the graph (the y axis) compared to a range of future five-year net charge-offs on the horizontal axis (the x axis). The CDF reflects the collected intelligence reflected in the pessimistic, most likely, and optimistic estimates of all the providers. For the mathematics and algorithms underlying the derivation of the CDF, please see below section on mathematics. For basic software coding underlying the functionality of the CDF of the invention, please see below section on coding. As any estimate is modified and resaved the CDF automatically is recomputed and saved.

Probabilistic Estimate and a Further Definition of the Cumulative Distribution Function (CDF)

From a general standpoint, what we are trying to do is reasonably predict an outcome. It has been said there is no such thing as truth only probability. One cannot stop at predicting an outcome, one must also qualify the prediction by stating the chance of it happening. Many discussions of probability theory start with the example of a coin toss, for example, that there is a 50% chance that one coin toss comes up tails. But what if there is more than two possible outcomes i.e. that what we were tossing had three sides? Furthermore what if there were ten people flipping the object and we wanted to get a view of the result of all these ten people? These additional questions are analogous to questions posed by the invention's predictive objective.

The invention's predictive objective is to represent the collective intelligence of all the providers given:

1) A range of possible outcomes.
2) A range of probabilities each provider attributes to any of the outcomes.
3) The need to know the chance of any individual outcome happening. This is an important requirement of the invention's mission. In the case of performing a diagnostic analysis on a bank, we need to know not only the level to which losses may mount to an unacceptable point, but also the chance of that unacceptable loss level occurring so that a regulator or a risk manager (for instance) can set aside loss reserves.

We start with each provider giving the 25% Pessimistic, 50% Most likely and 25% Optimistic cases, but this is just data. This data has to be transferred into the numerical equivalent of a probability density function a (PDF or bell curve). This is what the invention accomplishes initially.

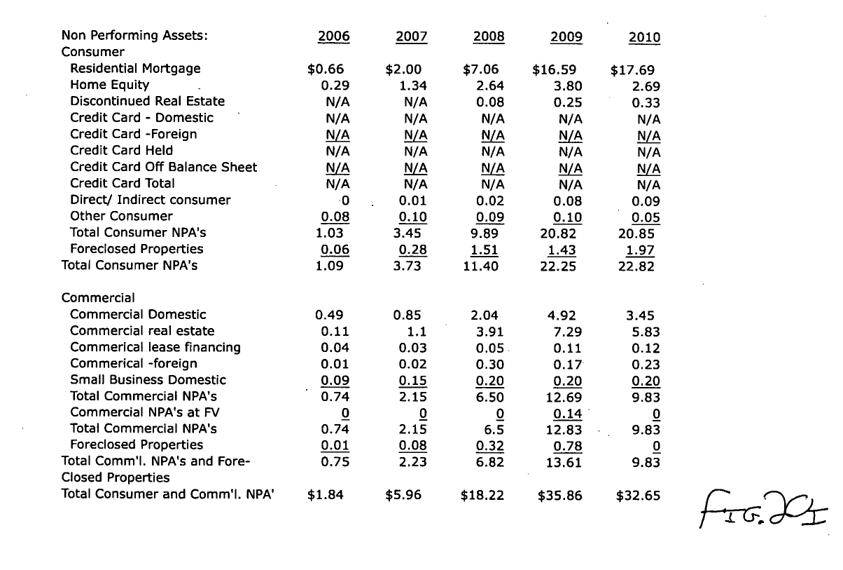

The next step is to aggregate the bell curves of all the providers into a weighted average probability density function that consists of one bell curve encompassing the individual bell curves and is uniquely determined by mean and standard deviation. This is what the algorithms accomplish in their second phase. One standard deviation from the mean will capture 67% of the outcomes. However, the weighted average probability function will not attribute a probability to one particular outcome and therefore doesn't satisfy the third requirement above, i.e., the need to know the chance of any individual outcome happening. However, the weighted average probability distribution is a necessary second step as part of the algorithms that achieve all the requirements. Therefore it is necessary to take a final step, which is to take the mathematical integral of the weighted average probability density function, which results in the cumulative distribution function or CDF. The CDF tells us the probability of any value for possible losses occurring. But it also has the advantage of telling simply what all the providers think i.e. in the case of FIG. 19 that there is better than a 95% chance that losses will be $60 billion and better than a 20% (one in five chance) that the losses could be as high as $125 billion. Unless we had taken this final step, i.e., we had derived the CDF, all we would know is that the providers collectively came up with a mean estimate for losses of $108.70 billion with a standard deviation of $18.20 billion, but not the odds of losses being as high as $125 billion. The CDF tells us that they are about 1 in 5. Investors risk managers, and regulators may be able to live with a high probability of losses being $60 billion but not with an approximate one in five chance of losses being $125 billion.

### Generating Provider Estimates and a Resulting Probabilistic Estimate for Pretax Pre-provision Earnings

As an additional feature, the invention may include a similar process for generating provider estimates and a resulting probabilistic estimate for pretax pre-provision earnings (please refer to discussion of pretax pre-provision earnings above) to match against the probabilistic estimate for future net charge-offs. This would be a measurement of the bank's ability from its future core earnings to cover future loan losses. By contrast, in the basic embodiment, a user of the service has only the latest 12-month actual pretax pre-provision earnings to compare against actual historic net charge offs and future net charge offs (which is itself useful).

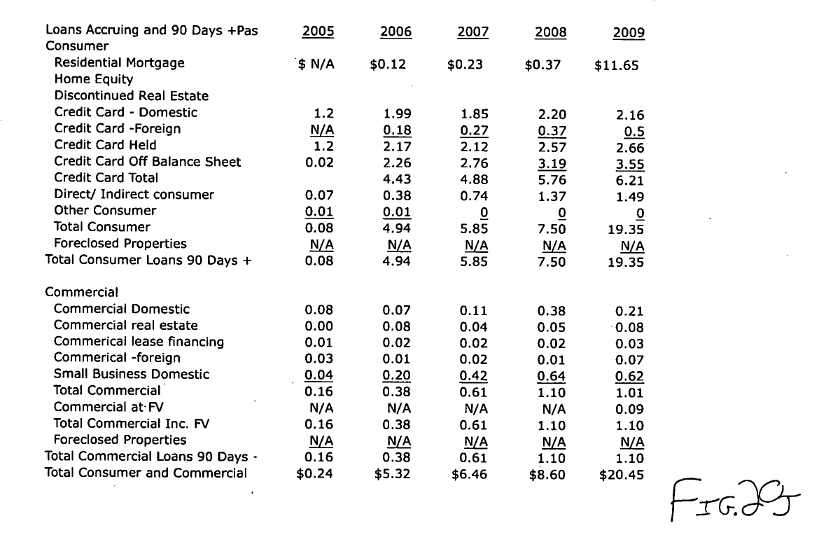

Inputs for the web based database are shown in FIGS. 20A-J. This is the majority of the sources in terms of data for the site's content. It consists of data extracted from public filings either through parsing or manual extraction.

In general, banks report for the consolidated entity, bank subsidiaries, and parent basic financials and loan detail. For the purposes of the instant embodiment of the invention, we are relying on basic financials and loan detail for the consolidated entity only.

Basic financials consist of:
The current consolidated balance sheet

### Current Selected Earnings and Capital Adequacy Statistics Earnings Impact From Assets Subject to Valuation Change

Past 4 fiscal years

Past 4 recent quarters.

Current and Historic Unrealized gains and losses from available for sale securities

Past 4 fiscal years

Recent 4 quarters

### Current Trading Account Asset and Liability Detail

### Current Level 3 Asset Total and Detail

### Current Structured Financings and Other

The above data of Basic Financials is selected as the key elements for the diagnostic process explained above.
Loan Detail consist of:

### Loans by Category

Past 6 fiscal years

Past 8 Quarters

Either Charge-Offs or Charge-Off ratios by Loan Category.

Past 5 fiscal years

Past 8 Quarters

### Either Non Performing Loans or Non Performing Loans as a % of Related Loans

Past 5 fiscal years

Past 8 Quarters

### Either Accruing and 90 Day+Past Due or Accruing and 90 Day+Past Due as a % of Related Loans

Past 5 fiscal years

Past 8 Quarters

Adjustments to include Off Balance Sheet Credit Card Loans

Past 6 fiscal years

Past 8 quarters

Adjustments to include Off Balance Sheet Charge-Offs

Past 6 Fiscal Years

Past 8 Quarters

The above data of Loan Detail is selected as the key elements for the estimate of future loan losses with the average charge off method in mind. The historical relationship of loan losses to loan amounts is a reasonable guide to what future losses will be if we make reasonable assumptions as to loan growth and charge-off ratios (please refer to the discussion of the average charge-off method above). Additionally there is other important data, which gives clues to estimate providers as to what future charge-off ratios might be. This other important data includes non-performing loan levels and accruing and 90+past due loan levels, usually found in the notes to financial statements, these two measures are the most likely sources of loans to be charged off imminently. Finally, at least for the very large bank holding companies, stated levels of credit card loan amounts and credit charge-offs are understated for our purposes by the fact that a disclosed and material amount of such loans and charge-offs are carried off balance sheet, they have to be added back explaining the need for the “Adjustments . . . ” data listed above.

Basic Financials can be found on specific bank websites under:

Earnings releases or press releases and

Supplemental Information

10K's and 10Q's.

Loan Detail is in two places namely the sites mentioned above or the Federal Reserve website in two reports called the BHCPR or FRY-9C.

Optionally, the database of the invention includes other data on these sites or other sources. Additionally, the invention contemplates enabling users coming to the site to help populate the database for many of the banks by providing them with an instruction set to do so, thereby using social networking to provide raw data for financial analysis. To ensure the data obtained in this manner is accurate, not only are users provided with an instruction set but also an input grid (not shown) or similar interface with specific references to the sources of “Basic Financials” and “Loan Detail” above. This input grid is designed to meet industry standards of consistency, conservatism, and conformity and is reviewed from the standpoint of quality control by the entity managing the inventive system.

Site Software Architecture: On the server side, the system is based upon a web application—built using the PHP language and the CodeIgniter open source framework—which is backed by a relational database, created using the MySQL open source database engine. Raw data from financial statements is entered into the database either by importing an Excel file, or manually via direct interaction with the MySQL system. The PHP application is responsible for receiving all requests from browser applications and delivering the appropriate response. The MySQL database provides a means of persistent storage for all necessary raw data.

The basic structure of the user interface is designed using the HTML markup language, and the overall appearance/layout is controlled using cascading style sheets (CSS) with the aid of the Blueprint open source CSS framework. The interactions that take place inside the user interface (tab-based navigation, pop-up dialogs, etc.) are implemented using the JavaScript client-side language in conjunction with the jQuery open source JavaScript framework.

In order to display data to the user, the JavaScript system sends a request to the server application containing the relevant information (type of data, date range, etc.). The PHP application then retrieves all necessary raw data from the database. If any data processing is necessary to fulfill the request, the calculations are performed on-the-fly using PHP routines. Once the data has been assembled, it is transformed into an HTML markup representation and sent back to the client application where it can be presented to the user.

### Coding

### Input Format

This piece of PHP code uses GET method to receive an input as a string which contains 15 numerics. The first 3 of these 15 numbers stand for the 25% pessimistic, 50% most likely, and 25% optimistic estimates of the first customer's input, and so on so forth till the very end of these 15 numbers.

### Numerical Integration

• trapezoidal rule:

function trapezoidal(lo, hi, NN)

{ var width = (hi−lo)/NN;

var sum = (Math.exp(−lo*lo)+Math.exp(−hi*hi))/2;
var i;
for(i=1; i < NN; i++)

sum += Math.exp(−((lo*(NN−i) +
hi*i)/NN)*((lo*(NN−i) + hi*i)/NN));

return sum*width;

}

• rectangle rule:

function rectangle(lo, hi, N)

{ var width = (hi−lo)/N;

var sum = 0;
var i;
for(i=0; i < N; i++)

sum += Math.exp(−( lo+(i+0.5)*width )*(
lo+(i+0.5)*width ));

return sum*width;

}

### Plotting

We use a jQuery plugin flot to do the plotting job,

function plot(myString) {
$(function ( ) {

var bc1 = [ ], bc2 = [ ]; bc3 = [ ]; bc4 = [ ]; bc5 = [ ] ; ba =[ ]; ca =[ ];
//var myString = new String(″<?php echo $_GET[″input″]; ?>″);
var myArray = myString.split (’,’);
var b11 = parseFloat(myArray[0]); b12 = parseFloat(myArray[1]); b13 = parseFloat(myArray[2]);
var b21 = parseFloat(myArray[3]); b22 = parseFloat(myArray[4]); b23 = parseFloat(myArray[5]);
var b31 = parseFloat(myArray[6]); b32 = parseFloat(myArray[7]); b33 = parseFloat(myArray[8]);
var b41 = parseFloat(myArray[9]); b42 = parseFloat(myArray[10]);b43 = parseFloat(myArray[11]);
var b51 = parseFloat(myArray[12]);b52 = parseFloat(myArray[13]);b53 = parseFloat(myArray[14]);
var ba1 = (b11 + b21 + b31 + b41 + b51) / 5.0;
var ba2 = (b12 + b22 + b32 + b42 + b52) / 5.0;
var ba3 = (b13 + b23 + b33 + b43 + b53) / 5.0;
var mu1 = (b11 + b12 + b13) / 3.0;
var sigma1 = (b13 − b11) / 1.35;
var mu2 = (b21 + b22 + b23) / 3.0;
var sigma2 = (b23 − b21) / 1.35;
var mu3 = (b31 + b32 + b33) / 3.0;
var sigma3 = (b33 − b31) / 1.35;
var mu4 = (b41 + b42 + b43) / 3.0;
var sigma4 = (b43 − b41) / 1.35;
var mu5 = (b51 + b52 + b53) / 3.0;
var sigma5 = (b53 − b51) / 1.35;
var mua = (ba1 + ba2 + ba3) / 3.0;
var sigmaa = (ba3 − ba1) / 1.35;
for (var i = 0.0; i < mua*2.15; i+=0.05) {
bc1.push([i, Math.exp(−(i−mu1)*(i−mu1)/2/sigma1/sigma1)*0.4/sigma1]);

bc2.push([i, Math.exp(−(i−mu2)*(i−mu2)/2/sigma2/sigma2)*0.4/sigma2]);

```
  bc3.push([i, Math.exp(−(i−mu3)*(i−mu3)/2/sigma3/sigma3)*0.4/sigma3]);
  bc4.push([i, Math.exp(−(i−mu4)*(i−mu4)/2/sigma4/sigma4)*0.4/sigma4]);
```

bc5.push([i, Math.exp(−(i−mu5)*(i−mu5)/2/sigma5/sigma5)*0.4/sigma5]);

```
  ba.push([i, Math.exp(−(i−mua)*(i−mua)/2/sigmaa/sigmaa)*0.4/sigmaa]);
  ca.push([i, 1.0−1.0/2.0*(1.0+2.0/Math.sqrt(3.1415)*rectangle(0.0,(i−mua)/Math.sqrt(2.0)/sigmaa,500)
}
var test_d1 = 324.3002;
var plot = $.plot($(″#placeholder″), [ { data: ca, label: ″Cumulative Probability Density Function
```

series: {

```
  lines: { show: true },
  points: { show: false }
```

```
  },
  grid: { hoverable: true, clickable: true },
  yaxis: { min: −0.05, max: 1.05, tickFormatter: function (v, axis) { return ″Probability :
```

xaxis: { tickFormatter: function (vv, axis) { return ″$″+String(vv.toFixed(axis.tickDecimals)*1.0) :

});

function showTooltip(x, y, contents) {

$(’<div id=″tooltip″>’ + contents + ’</div>’).css( {

position: ’absolute’,
display: ’none’,
top: y + 5,
left: x + 5,
border: ’1px solid #fdd’,
padding: ’2px’,
’background-color’: ’#fee’,
opacity: 0.80

}).appendTo(″body″).fadeIn(200);

}
var previousPoint = null;
$(″#placeholder″).bind(″plothover″, function (event, pos, item) {

| | |
|---|---|
| | $(″#x″).text(pos.x.toFixed(3)); |
| | $(″#y″).text(pos.y.toFixed(3)); |
| // | if ($(″#enableTooltip:checked″).length > 0) { |

if (item) {

if (previousPoint != item.datapoint) {

previousPoint = item.datapoint;
$(″#tooltip″).remove( );
var x = item.datapoint[0].toFixed(3),

y = item.datapoint[1].toFixed(3);

showTooltip(item.pageX, item.pageY,

item.series.label + ″ of ″ + x + ″ = ″ + y);

}

}
else {

$(″#tooltip″).remove( );
previousPoint = null;

}

| | |
|---|---|
| // | } |

```
  });
  $(″#placeholder″).bind(″plotclick″, function (event, pos, item) {
```

if (item) {

$(″#clickdata″).text(″You clicked point ″ + item.dataIndex + ″ in ″ + item.series.label + ″.
plot.highlight(item. series, item.datapoint);

plot2.highlight(item. series, item.datapoint);
}

});

});
}
Notes:
the above function could only deal with javascript strings, i.e. the parameter is a javascript string. However, the page input is a PHP string. So a PHP2Javascript converting is necessary, which could be put as below:
var myString = new String(″<?php echo $_GET[″input″]; ?>″);
By doing so, we are able to pass this Javascript string to the plot function so that we will get the chart:
plot(myString);

### Algorithms

### Generating Bell Curves

### 1.1 Mathematical Modelling

We are asked to determine a bell curve by three points. This job is doable because a bell curve is uniquely determined by two parameters: μ and σ. The probability density function of a bell curve is

$$y = \frac{1}{\sqrt{2 π {σ}^{2}}} {e}^{- \frac{{( x - μ )}^{2}}{2 {σ}^{2}}} \qquad ( 1.1 )$$

with its cumulative density function being

$$y = \frac{1}{2} [ 1 + erf ( \frac{x - μ}{\sqrt{2 {σ}^{2}}} ) ] \qquad ( 1.2 )$$

where er ƒ is the error function defined as:

$$erf ( x ) = \frac{2}{\sqrt{π}} {\int }_{0}^{x} {e}^{- {t}^{2}} d t \qquad ( 1.3 )$$

By easy computation or statistical table check-up, we know that for a standard bell curve, the points standing for “25%” optimistic and “25%” pessimistic locate 0.675 away from 0, which means the three points of input approximate μ−0.675σ, μ and μ+0.675σ.

### 1.2 Numerical Approximation

Following what has been done above, we naturally ask a question: how to find the best fitted μ and σ based on our input triple (x₁, x₂, x₃)? Easily, this question could be formulated as an optimization problem

$${min}_{μ , σ} {‖ ( μ - 0.675 σ , μ , μ + 0.675 σ ) - ( {x}_{1} , {x}_{2} , {x}_{3} ) ‖}_{{l}_{2}} \qquad ( 1.4 )$$

The solution comes from solving the FOL condition, that is:

$$\begin{matrix}μ = \frac{{x}_{1} + {x}_{2} + {x}_{3}}{3} & ( 1.5 ) \\ σ = \frac{{x}_{3} - {x}_{1}}{1.35} & ( 1.6 )\end{matrix}$$

As we have five sets of input, we need to do the above computation for 5 times so that we obtain μ⁽¹⁾, μ⁽²⁾, μ⁽³⁾, μ⁽⁴⁾, μ⁽⁵⁾ and σ⁽¹⁾, σ⁽²⁾, σ⁽³⁾, σ⁽⁴⁾, σ⁽⁵⁾ as:

$$\begin{matrix}{μ}^{( 1 )} = \frac{{x}_{1}^{( 1 )} + {x}_{2}^{( 1 )} + {x}_{3}^{( 1 )}}{3} & ( 1.7 ) \\ {σ}^{( 1 )} = \frac{{x}_{3}^{( 1 )} - {x}_{1}^{( 1 )}}{1.35} & ( 1.8 ) \\ {μ}^{( 2 )} = \frac{{x}_{1}^{( 2 )} + {x}_{2}^{( 2 )} + {x}_{3}^{( 2 )}}{3} & ( 1.9 ) \\ {σ}^{( 2 )} = \frac{{x}_{3}^{( 2 )} - {x}_{1}^{( 2 )}}{1.35} & ( 1.10 ) \\ {μ}^{( 3 )} = \frac{{x}_{1}^{( 3 )} + {x}_{2}^{( 3 )} + {x}_{3}^{( 3 )}}{3} & ( 1.11 ) \\ {σ}^{( 3 )} = \frac{{x}_{3}^{( 3 )} - {x}_{1}^{( 3 )}}{1.35} & ( 1.12 ) \\ {μ}^{( 4 )} = \frac{{x}_{1}^{( 4 )} + {x}_{2}^{( 4 )} + {x}_{3}^{( 4 )}}{3} & ( 1.13 ) \\ {σ}^{( 4 )} = \frac{{x}_{3}^{( 4 )} - {x}_{1}^{( 4 )}}{1.35} & ( 1.14 ) \\ {μ}^{( 5 )} = \frac{{x}_{1}^{( 5 )} + {x}_{2}^{( 5 )} + {x}_{3}^{( 5 )}}{3} & ( 1.15 ) \\ {σ}^{( 5 )} = \frac{{x}_{3}^{( 5 )} - {x}_{1}^{( 5 )}}{1.35} & ( 1.16 )\end{matrix}$$

1.3 Averaging

The same methodology is applied to the arithmetic average of 25% pessimistic, 50% neutral and 25% optimistic inputs, i.e. we get a bunch of five x₁s and take the average so that we have) x̅₁, x̅₂, x̅₃ as:

$$\begin{matrix}{\overline{x}}_{1} = \frac{{x}_{1}^{( 1 )} + {x}_{1}^{( 2 )} + {x}_{1}^{( 3 )} + {x}_{1}^{( 4 )} + {x}_{1}^{( 5 )}}{5} & ( 1.17 ) \\ {\overline{x}}_{2} = \frac{{x}_{2}^{( 1 )} + {x}_{2}^{( 2 )} + {x}_{2}^{( 3 )} + {x}_{2}^{( 4 )} + {x}_{2}^{( 5 )}}{5} & ( 1.18 ) \\ {\overline{x}}_{3} = \frac{{x}_{3}^{( 1 )} + {x}_{3}^{( 2 )} + {x}_{3}^{( 3 )} + {x}_{3}^{( 4 )} + {x}_{3}^{( 5 )}}{5} & ( 1.19 )\end{matrix}$$

Naturally we do the approximation for the averaged inputs:

$$\begin{matrix}\overline{μ} = \frac{{\overline{x}}_{1} + {\overline{x}}_{2} + {\overline{x}}_{3}}{3} & ( 1.20 ) \\ \overline{σ} = \frac{{\overline{x}}_{3} - {\overline{x}}_{1}}{1.35} & ( 1.21 )\end{matrix}$$

Having described certain embodiments of the invention, it should be understood that the invention is not limited to the above description or the attached exemplary drawings. Rather, the scope of the invention is defined by the claims appearing hereinbelow and any equivalents thereof as would be appreciated by one of ordinary skill in the art.

What is claimed is:

1. A method of probabilistically projecting at least one industry-specific key operating statistic for a selectable business entity within that industry, comprising the steps of:
a) presenting, to a plurality of users, historical data about a business entity within a specific industry, the data including at least one key operating statistic;
b) enabling each of the users to make at least one projection of the key operating statistic for the business entity; and
c) aggregating all of the projections created via said enabling step into a single probabilistic expression.

2. A method of probabilistically projecting at least one industry-specific key operating statistic according to claim 1, wherein step c) expresses not only a range of projected magnitudes of the key operating statistic but also the respective chances of the projected magnitudes occurrences.

3. A method of probabilistically projecting at least one industry-specific key operating statistic according to claim 1, wherein the single probabilistic expression comprises a cumulative probability density function.

4. A method of probabilistically projecting at least one industry-specific key operating statistic according to claim 1, said step a) further comprising the steps of:
presenting a plurality of key operating statistics; and
presenting macroeconomic data to the user relevant to the industry.

5. A method of probabilistically projecting at least one industry-specific key operating statistic according to claim 4, step b) further comprising the steps of having the user:
i) examine the plurality of key operating statistics;
ii) select one of the key operating statistics from the plurality of key operating statistics based on the presented macroeconomic data;
iii) generate at least one projection of the key operating statistic.

6. A method of probabilistically projecting at least one industry-specific key operating statistic according to claim 5, said step iii) further comprising the steps of:
providing a plurality of projections of the selected key operating statistic;
assigning to each projection in the plurality of projections a level of likelihood of occurrence.

7. A method of probabilistically projecting at least one industry-specific key operating statistic according to claim 6, wherein said assigning step comprises the step of selecting from among a fixed number of preset likelihoods.

8. A method of probabilistically projecting at least one industry-specific key operating statistic according to claim 7, wherein the fixed number of present likelihoods is at least three likelihoods.

9. A method of probabilistically projecting at least one industry-specific key operating statistic according to claim 7, wherein the fixed number of preset likelihoods includes a 25% pessimistic outcome, a 50% most likely outcome, and a 25% optimistic outcome.

10. A method of probabilistically projecting at least one industry-specific key operating statistic according to claim 6, wherein said assigning step comprises the step of allowing the user to self-generate likelihoods for the user's projections.

11. A method of probabilistically projecting at least one industry-specific key operating statistic according to claim 6, step c) further comprising the steps of:
converting each of the projections of the users into the numerical equivalent of a probability density function;
converting the probability functions into a weighted average probability function;
taking the integral of the weighted average probability distribution to create a cumulative probability density function.

12. A method of probabilistically projecting at least one industry-specific key operating statistic according to claim 6, wherein the minimum number of users is 5, and the minimum number of projections per user is 3.

13. A method of probabilistically projecting at least one industry-specific key operating statistic according to claim 11, wherein said taking the integral step is approximated.

14. A method of probabilistically projecting at least one industry-specific key operating statistic according to claim 13, wherein said taking the integral step is approximated via at least one of the trapezoidal rule or the rectangle method.
